(19) United States
(12) Patent Application Publication
(10) Pub. No.: US 2011/0307354 A1
(43) Pub. Date: Dec. 15, 2011

(54) METHOD AND APPARATUS FOR RECOMMENDING APPLICATIONS TO MOBILE USERS

(76) Inventors: Bilgehan Erman, Marlboro, NJ (US); Ramesh Nagarajan, Princeton Junction, NJ (US); Huseyin Uzunalioglu, Millington, NJ (US)

(21) Appl. No.: 12/796,771

(22) Filed: Jun. 9, 2010

(51) Int. Cl. G06Q 99/00; G06Q 30/00; G06F 15/16; G06F 9/445; G06F 3/048; G06Q 50/00; G06F 21/00

(52) U.S. Cl. 705/27.1; 705/347; 717/178; 715/846; 709/203; 705/26.7

(57) ABSTRACT

Various deficiencies in the prior art are addressed by embodiments for recommending applications to users. A method and apparatus are provided for selecting an application to recommend to a user based on user profile information associated with the user and application profile information associated with the application, and propagating recommended application information toward a user device of the user, where the recommended application information includes an application executable of the recommended application. A method and apparatus are provided for receiving, at a user device, recommended application information comprising an application executable of an application recommended for a user of the user device, and automatically installing the application executable on the user device.

### FIELD OF THE INVENTION

The invention relates generally to applications and, more specifically but not exclusively, to recommending applications to users.

### BACKGROUND

With the growing popularity of smartphones, the number of mobile applications developed for smartphones is rapidly increasing. Following the debut of the Apple App Store in July 2008, the number of downloads of mobile applications from the Apple App Store reached one billion in only nine months. Today, there are tens of thousands of mobile applications available just from the Apple App Store. Similarly, other smartphone providers have launched similar application stores having large numbers of available applications. Furthermore, the number of available applications is continuing to increase and is expected to do so in the future. This explosive growth in the number of application stores, and the number of mobile applications available from the application stores, provides mobile users with a large variety of available mobile applications. Disadvantageously, however, this explosive growth also presents problems for both application developers that develop the mobile applications and the mobile users using the mobile applications. For the application developers, the large number of available mobile applications is making it difficult for the application developers to market their mobile applications. For most mobile users, the large number of available mobile applications is making it difficult to find out about mobile applications that the mobile users might like to use. Furthermore, even many of the more advanced mobile users, who are more familiar with mobile applications, are finding it quite difficult to locate relevant mobile applications, unless they are willing to spend an extensive amount of time searching through the available mobile applications.

### SUMMARY

Various deficiencies in the prior art are addressed by embodiments for recommending applications to users. A method and apparatus are provided for selecting an application to recommend to a user based on user profile information associated with the user and application profile information associated with the application, and propagating recommended application information toward a user device of the user, where the recommended application information includes an application executable of the recommended application. A method and apparatus are provided for receiving, at a user device, recommended application information comprising an application executable of an application recommended for a user of the user device, and automatically installing the application executable on the user device.

### BRIEF DESCRIPTION OF THE DRAWINGS

The teachings herein can be readily understood by considering the following detailed description in conjunction with the accompanying drawings, in which:

FIG. 1 depicts a high-level block diagram of an exemplary application recommendation system;

FIG. 2A depicts one embodiment of a method for generating user profile information for a user for use in recommending applications to the user;

FIG. 2B depicts one embodiment of a method for generating application profile information for applications for use in recommending applications to users;

FIG. 2C depicts one embodiment of a method for recommending applications to a user;

FIG. 3A depicts one embodiment of a method for providing user profile information of a user;

FIG. 3B depicts one embodiment of a method for indicating availability of recommended application information to a user;

FIG. 4 depicts a high-level block diagram of one embodiment of a mobile device supporting an Application Guide;

FIG. 5 depicts an exemplary representation of a mobile device, illustrating a main screen of the mobile device including an Application Guide icon;

FIG. 6A depicts an exemplary representation of a recommended applications tab of an exemplary Application Guide;

FIG. 6B depicts an exemplary representation of an installed applications tab of an exemplary Application Guide;

FIG. 6C depicts an exemplary representation of an application search tab of an exemplary Application Guide;

FIG. 6D depicts an exemplary representation of a user information tab of an exemplary AppGuide; and

FIG. 7 depicts a high-level block diagram of a computer suitable for use in performing the functions described herein.

To facilitate understanding, identical reference numerals have been used, where possible, to designate identical elements that are common to the figures.

### DETAILED DESCRIPTION OF THE INVENTION

An application recommendation capability is depicted and described herein. The application recommendation capability is configured for automatically providing application recommendations to users. The application recommendation capability uses an application guide server that is configured for selecting recommended applications for a user and for providing recommended application information associated with the recommended applications to the user. The application recommendation capability uses a user device that is configured for presenting recommended application information associated with applications recommended by the application guide server. The user device may include an application guide configured for presenting application recommendation information, as well as other application related information. The application recommendation information may include one or more application executables which are downloaded to the user device and installed on the user device such that the user may preview the associated applications and decide whether or not to purchase the applications. It will be appreciated that the foregoing description of the application recommendation capability is provided for purposes of introducing embodiments of the application recommendation capability and, therefore, that various other embodiments of the application recommendation capability may be supported.

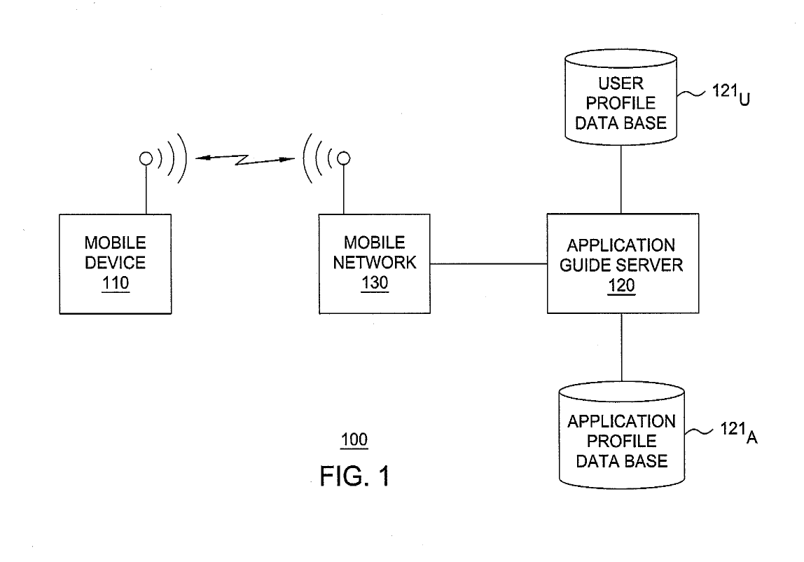

FIG. 1 depicts a high-level block diagram of an exemplary application recommendation system. As depicted in FIG. 1, exemplary application recommendation system 100 includes a mobile device (MD) 110 and an application guide server (AGS) 120. The MD 110 and AGS 120 communicate via a mobile network (MN) 130. The AGS 120 has a user profile database 121_{U} and an application profile database 121_{A} associated therewith (which may be referred to collectively herein as profile databases 121).

The MD 110 is a mobile device suitable for use with the application recommendation capability. For example, MD 110 may be a smartphone, a cellular phone, or any other suitable mobile device. The MD 110 may communicate with MN 130 using any suitable wireless technologies (e.g., using one or more of cellular communications, WiFi communications, and the like). The MD 110 is used by one or more users, which may use applications available on MD 110. The MD 110 supports an Application Guide (primarily referred to herein as an AppGuide) configured to present application information associated with applications which may be used on MD 110.

The AGS 120 is an application guide server configured to recommend applications to users. The AGS 120 recommends applications to users by selecting applications as recommended applications for users and providing recommended application information associated with the recommended applications to the mobile devices of the users.

The AGS 120 selects recommended applications for a mobile user using profile information, which includes: (1) user profile information associated with the user for which the applications are selected and (2) application profile information associated with applications available for selection as recommended applications for the user. The user profile information and application profile information may be referred to collectively herein as profile information.

As depicted in FIG. 1, for example, AGS 120 selects recommended applications for the mobile user of MD 110 and provides recommended application information to MD 110 for presentation to the user using MD 110.

The user profile information associated with a user includes information suitable for use in determining applications that will or may be of interest to the user. The user profile information may be received by AGS 120 from any suitable source(s) of such information. In one embodiment, for example, the user profile information is received from one or more databases storing user profile information for use by AGS 120. In one embodiment, for example, AGS 120 receives user profile information from one or more of one or more local databases available on AGS 120, one or more remote databases with which AGS 120 is capable of communicating, and the like, as well as various combinations thereof. In one such embodiment, for example, AGS 120 receives user profile information from user profile database 121_{U} accessible to AGS 120. The AGS 120 may receive at least a portion of the user profile information directly from MD 110.

The user profile information for a user may include and/or be may be derived from any suitable raw user information, such as personal information of the user (e.g., gender, age, and the like), user preference information (e.g., the interests, hobbies, favorite types of music, favorite television programs, favorite movie genres, favorite types of applications, and like user preference information), user activity information (e.g., Internet browsing history that is monitored and logged on the mobile device of the user and/or within the network, the types of applications purchased and used by the user, the characteristics of specific applications purchased and used by the user, and like user activity information), and the like, as well as various combinations thereof. The user profile information may be determined using any suitable user profiling technologies, as will be understood by one skilled in the art. The profiling of users, using such user profiling technologies, may be performed by any suitable profiler (e.g., by AGS 120, by one or more other systems for generating the user profile information for use by AGS 120, and the like, as well as various combinations thereof). The user profile information may be maintained using any suitable type of data structure(s). The raw user information that is included within the user profile information and/or used to generate the user profile information may be received from any suitable source of such information (e.g., from the mobile devices of the users, from network-based user information sources such as Home Subscriber Servers (HSSs) and like network-based sources, and the like, as well as various combinations thereof). In one embodiment, user profile information is determined from raw user information using user profiling technologies, and the determined user profile information is stored for use by AGS 120 in recommending applications to the user (e.g., stored within user profile database 121_{U} accessible from AGS 120).

The application profile information associated with an application includes information suitable for use in describing the application such that it is possible to identify users that will or may be interested in the application. The application profile information may be received by AGS 120 from any suitable source(s) of such information. In one embodiment, for example, the application profile information is received from one or more databases storing application profile information for use by AGS 120. In one embodiment, for example, AGS 120 receives application profile information from one or more of one or more local databases available on AGS 120, one or more remote databases with which AGS 120 is capable of communicating, and the like, as well as various combinations thereof. In one such embodiment, for example, AGS 120 receives application profile information from application profile database 121_{A} accessible to AGS 120.

The application profile information for an application may include and/or may be derived from raw application description information, such as a description of the application, indications as to the types of users to which the application is targeted (e.g., based on characteristics of users), and the like, as well as various combinations thereof. The application profile information may be determined using any suitable application profiling technologies, as will be understood by one skilled in the art. The profiling of applications, using such application profiling technologies, may be performed by any suitable profiler (e.g., by AGS 120, by one or more other systems for generating the application profile information for use by AGS 120, and the like, as well as various combinations thereof). The application profile information may be maintained using any suitable type of data structure(s). The raw application description information that is included within the application profile information and/or used for generating the application profile information may be received from any suitable source of such information (e.g., from systems of application providers that provide the applications, from administrators of the application providers, and the like, as well as various combinations thereof). In one embodiment, application profile information is determined from raw application information using application profiling technologies, and the determined application profile information is stored for use by AGS 120 in recommending the application to the users (e.g., stored within application profile database 121_{A} accessible from AGS 120).

The AGS 120 receives the profile information for purposes of selecting applications to be recommended for one or more users. The AGS 120 may receive the profile information automatically and/or in response to requests by AGS 120 for the profile information. The AGS 120 receives the profile information, for purposes of selecting applications to be recommended for one or more users, in any suitable manner (e.g., from any suitable source(s) of such information, in any suitable format, in response to any suitable trigger condition(s), and the like, as well as various combinations thereof).

The AGS 120 receives the profile information, for purpose of selecting applications to be recommended for one or more users, from any suitable source or sources of such information. In one embodiment, for example, AGS 120 receives profile information from one or more databases storing the profile information (e.g., profile databases 121). In one embodiment, for example, AGS 120 receives at least a portion of user profile information from one or more of mobile devices of the users, network-based user information sources (e.g., Home Subscriber Servers (HSSs) and other similar devices), and the like, as well as various combinations thereof. In one embodiment, for example, the AGS 120 receives at least a portion of the application profile information from one or more of one or more application provider systems of application providers, mobile devices of the users providing feedback on applications, and the like, as well as various combinations thereof. The AGS 120 may receive profile information from any other suitable source or sources of such information.

The AGS 120 receives the profile information, for purpose of selecting applications to be recommended for one or more users, in response to any suitable trigger conditions. The AGS 120 may receive the profile information in response to a query for the information initiated by AGS 120, e.g., upon a determination by AGS 120 that the application recommendation process, for selecting recommended applications, is to be executed for one or more users. The AGS 120 may receive profile information automatically, such as where portions of the profile information are pushed to AGS 120. The AGS 120 may receive profile information, for purpose of selecting applications to be recommended for one or more users, in response to any other suitable trigger conditions.

The AGS 120 receives the profile information, for purpose of selecting applications to be recommended for one or more users, in any suitable format, which may depend on the manner in which the profile information is stored for use by AGS 120. The profile information may be organized using any suitable type of data structure. For example, profile information may be specified using schemas, metadata, keywords, and the like, as well as various combinations thereof.

In this manner, AGS 120 has access to user profile information and application profile information which AGS 120 uses to select applications to recommend to users.

The AGS 120 selects applications to recommend to users based on matching of the user profile information and the application profile information. The matching of user profile information and application profile information for purposes of selecting applications to recommend to users may be performed using any suitable profile matching technologies.

The AGS 120 may perform matching of user profile information and the application profile information for purposes of selecting one or more applications to recommend to one or more users in response to any suitable trigger condition(s).

In one embodiment, for example, AGS 120 may select one or more applications for a user or users in response to one or more network-based trigger conditions. For example, AGS 120 may select one or more applications for a user or users periodically according to a schedule (e.g., a schedule determined by an administrator of AGS 120, a schedule(s) configured by the user(s), and the like), in response to receiving and/or detecting new or updated user profile information associated with the user(s), in response to receiving and/or detecting new or updated application profile information associated with one or more applications, in response to detecting change of location of the user(s), and the like, as well as various combinations thereof). In this manner, the network is capable of pushing application recommendations to the users.

In one embodiment, for example, AGS 120 may select one or more applications for a user or users in response to one or more user-based and/or application-based trigger conditions. For example, AGS 120 may select one or more applications for a user in response to a request received from a user, may select one or more applications for each of a plurality of users in response to a request received from an application provider, and the like, as well as various combinations thereof.

It will be appreciated that various combinations of such network-based and/or user-based trigger conditions may be used for triggering AGS 120 to select one or more applications to be recommended for a user or users.

The AGS 120 propagates recommended application information to the users. The recommended application information for a user may include any information suitable for use in informing the user of the recommended applications selected by AGS 120 for recommendation to the user.

In one embodiment, for example, recommended application information for a user includes a list of the recommended applications, which may include any suitable types and/or granularity of information (e.g., the names of the recommended applications, brief and/or detailed descriptions of the recommended applications, depictions of screens supported by the recommended applications, and the like). The list of recommended applications may include any suitable number of applications, may be organized in any suitable order (e.g., based on one or more of the strength of match of the application profile information of the applications to the user profile information of the users, popularity of the applications across groups of users or all users, or in any other suitable order), and the like, as well as various combinations thereof. The list of recommended applications provides information about the recommended applications which is useful to the user in deciding whether or not to purchase the recommended applications.

In one embodiment, for example, recommended application information for a user includes information adapted for enabling the user to use one or more of the recommended applications (e.g., on a preview basis, trial basis, and/or full use basis). In one such embodiment, the recommended application information includes one or more application executables for one or more recommended applications, respectively. The application executable for a recommended application may be an application preview executable which may be invoked by the user to preview the application, but without the full application functionality being available to the user. The application executable for a recommended application may be an application trial executable which may be invoked by the user to access the full functionality of the application for a certain period time after which the user must either purchase the application or the application trial executable becomes deactivated such that the user cannot continue to use the application for free. The application executable for a recommended application may be an application executable which may be invoked by the user such that the user has full access to the application for free (e.g., this may be an application that is provided to the user for free in order to motivate the user to use the Application Guide more regularly, in the hopes of renting or selling more applications to the user). It will be appreciated that any other types of application executables may be included as part of the recommended application information that is provided to the user. It will be appreciated that various combinations of such application executables may be included as part of the recommended application information that is provided to the user.

In one embodiment, for example, recommended application information includes information adapted for enabling the user to rent or purchase one or more of the recommended applications.

In one embodiment, combinations of such recommended application information may be provided to users. For example, the recommended application information may include a list of the top ten matching applications, as well as application executables for the top three matching applications in order to enable quicker preview by the user of the recommended applications most likely to be purchased by the user. For example, the recommended application information may include a list of the top twenty matching applications, an application trial executable for the top matching application, and application preview executables for three other recommended applications. It will be appreciated that any other suitable combinations of such information may be provided.

In one embodiment, the types and/or the amount of the recommended application information provided to a user may depend on the memory constraints associated with the mobile device of the user (e.g., the memory constraints associated with MD 110 for recommended application information to be provided from AGS 120 to MD 110). For example, the recommended application information provided to a user may depend on the amount of memory available on the mobile device of the user for storing the recommended application information, the amount of memory required for storing the recommended application information, and the like, as well as various combinations thereof. For example, where only a relatively small amount of memory is available on the mobile device of the user, the recommended application information may be limited to a list of the recommended applications (and possibly some application executables where such executables are relatively small). For example, where a relatively large amount of memory is available on the mobile device of the user, applications executables may be provided with the recommended application information (e.g., only one application executable where the size of the application executable is relative large, many application executables where at least some of the application executables are relatively small, and the like). The balancing of memory available on the mobile device of the user with the amount of the recommended application information will be understood by one skilled in the art. The balancing that is performed may be pre-determined, determined dynamically (e.g., based on one or more of interactions between the mobile device of the user and the AGS, the AGS and one or more network devices having information about the current state of memory available on the mobile device of the user, and the like), and the like, as well as various combinations thereof.

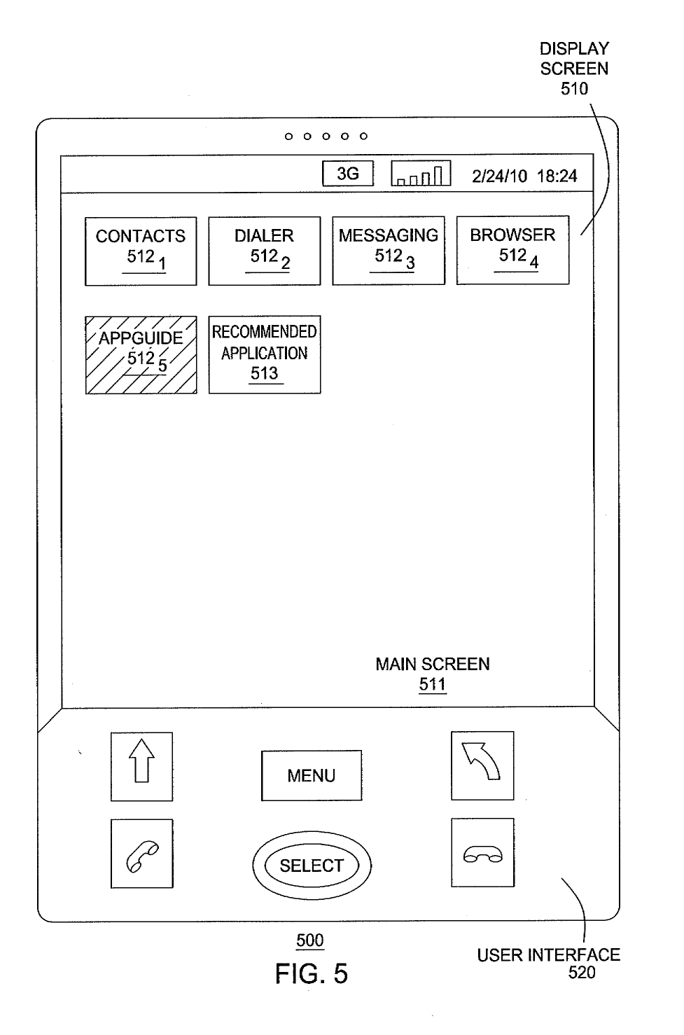

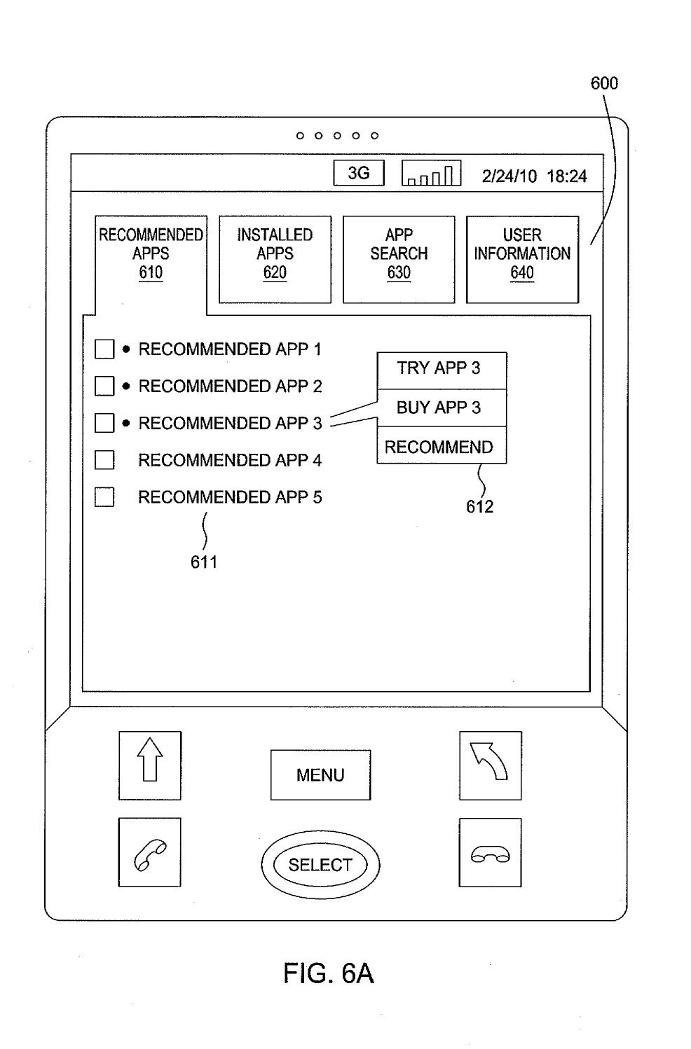

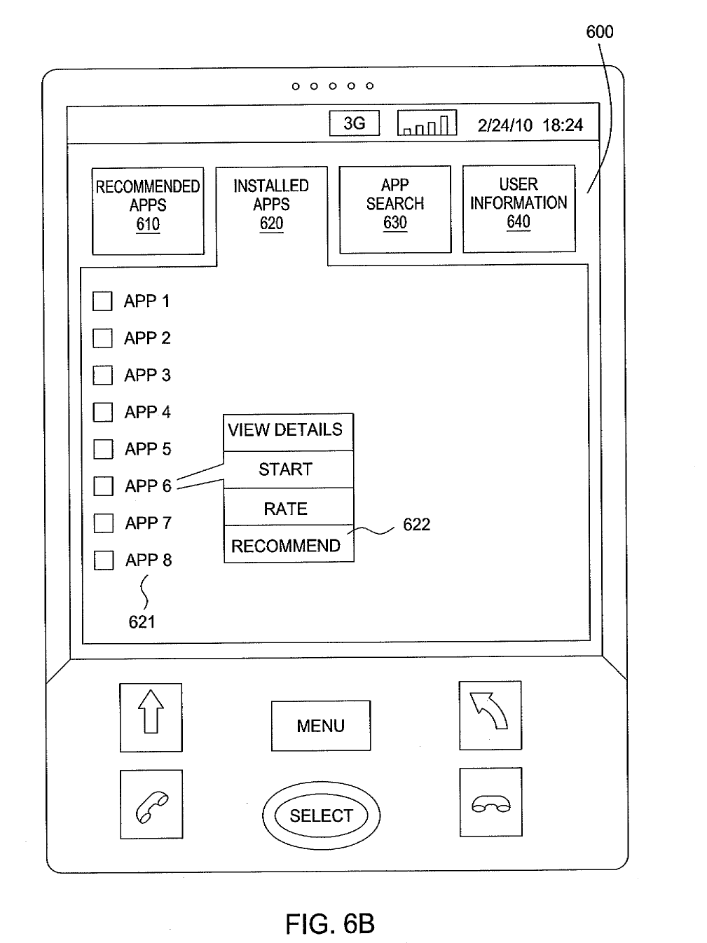

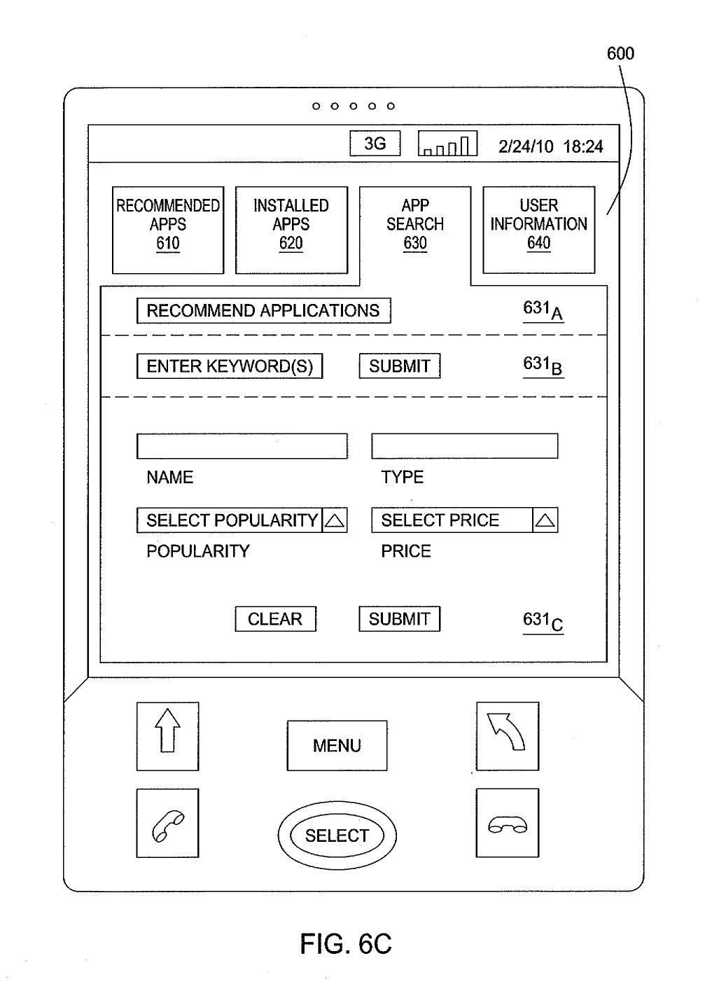

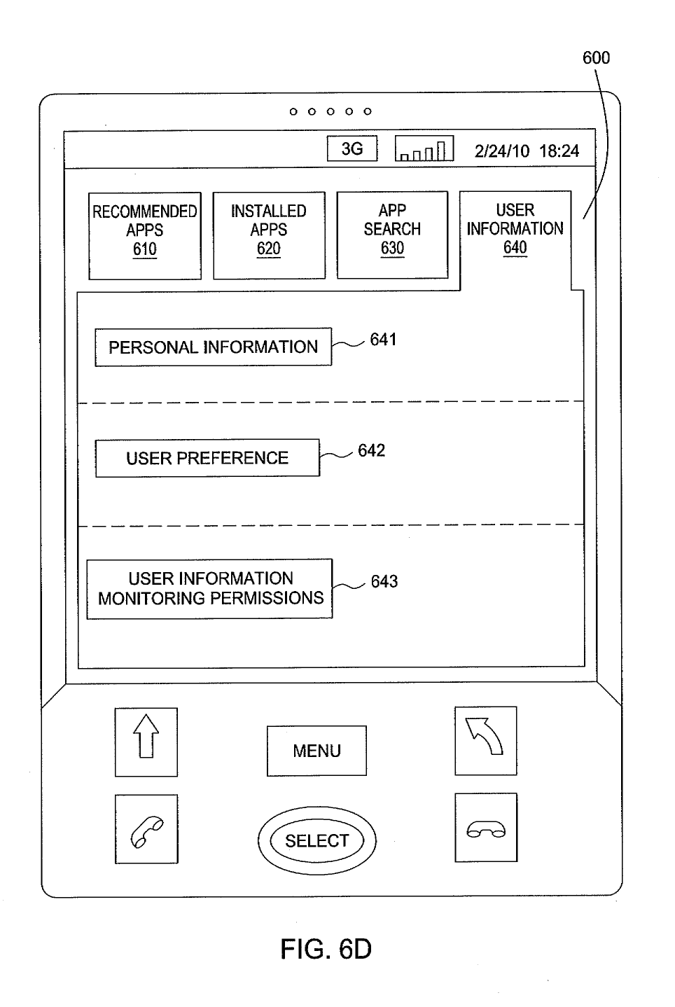

The MD 110 receives the recommended application information from AGS 120. The MD 110 stores the recommended application information for presentation to the user via MD 110. In one embodiment, in which the recommended application information includes an application executable of a recommended application, the application executable is automatically installed on MD 110. The MD 110 presents the recommended application information to the user using MD 110. The recommended application information may be presented to the user on MD 110 in any manner that is suitable for presenting such information. In one embodiment, the recommended application information is presented to the user on MD 110 via an AppGuide on MD 110. An exemplary AppGuide for use on MD 110 is depicted and described with respect to FIGS. 5 and 6A-6D.

The MD 110 is configured to manage portions of the recommended application information.

In one embodiment, for example, MD 110 is adapted to replace at least a portion of existing recommended application information with new recommended application information. In one embodiment, for example, MD 110 may replace existing recommended application information with new recommended application information in response to receiving new recommended application information (e.g., where new recommended application information is pushed to MD 110 by AGS 120, which may be periodically, in response to indications and/or requests received at AGS 120 from MD 110, and the like, as well as various combinations thereof). In one embodiment, for example, MD 110 may replace existing recommended application information with new recommended application information by initiating requests to AGS 120 for new recommended application information in response to one or more trigger conditions (e.g., in response to some or all of the existing recommended application information being outdated, in response to memory constraints, and the like, as well as various combinations thereof. For example, MD 110 may initiating requests to AGS 120 for new recommended application information in response to one or more of movement of an application from a list of recommended applications to a list of installed applications in response to a determination that the user has purchased a license to use the application, removal of an application from the list of recommended applications in response to the application being on the list of recommended applications for a threshold length of time, removal of an application from the list of recommended application in response to the user previewing the application but deciding not to purchase a license to use the application, and the like, as well as various combinations thereof.

In one embodiment, in which application executables are provided as part of the recommended application information, the application executables maintained on the mobile device may be updated in any suitable manner.

In one embodiment, the application executables are updated only when a full set of recommended application information is received at the mobile device (e.g., the application executables are changed when the list of recommended applications is received).

In one embodiment, the application executables may be updated independent of when the full set of recommended application information is received (e.g., the application executables may be updated incrementally based on one or more conditions). In one such embodiment, for example, application executables are downloaded so as to maintain a certain number of application executables on the mobile device (e.g., application executables for the top N recommended applications), such that a certain amount or percentage of memory of the mobile device is utilized for making application executables available to the user (e.g., such that no more than half of the memory of the mobile device is consumed), and the like, as well as various combinations thereof.

In one embodiment, an application executable downloaded to the mobile device has a lifetime associated therewith. In one such embodiment, the application executable is disabled or removed from the mobile device at the expiration of the lifetime unless one or more conditions are met (e.g., the user indicates that the user would like additional time to preview the application, the user initiates a request to purchase a license to use the application, a license for the application is purchased by the user, and the like).

In one embodiment, an application executable downloaded to the mobile device may have multiple lifetimes associated therewith. In one such embodiment, application executables for recommended applications are removed from the mobile device as follows: (1) each application executable that is not launched by the user is removed from the mobile device after x length of time and (2) each application executable that is launched by the user but not purchased by the user is removed from the mobile device after y length of time. In one such embodiment, y is greater than x (e.g., the user may try the application again). In one such embodiment, x is greater than y (e.g., the user is more likely to purchase applications that have not yet been previewed than applications that have been previewed but not purchased in response to the preview).

The MD 110 may be configured to perform such management functions, for managing recommended application information, at any suitable times (e.g., in real time as conditions are satisfied, per a predetermined schedule, and the like, as well as various combinations thereof).

The MD 110 is adapted to perform various other functions in support of the application recommendation capability.

The MN 130 facilitates communications between MD 110 and AGS 120. The MN 130 may be any mobile network suitable for supporting communications between MD 110 and AGS 120, such as a cellular network, a WiFi network, and the like, as well as combinations thereof.

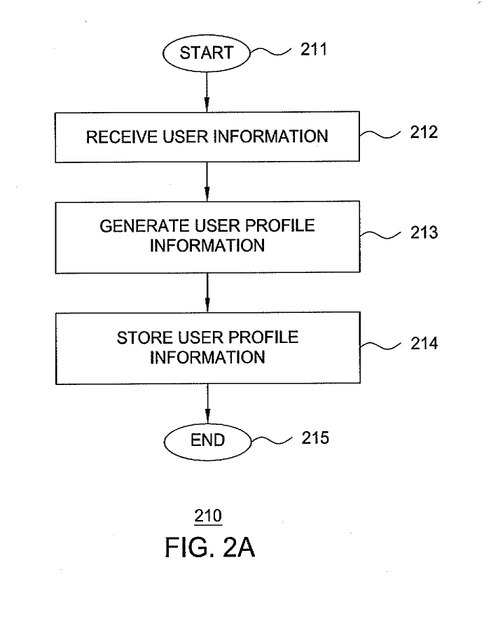

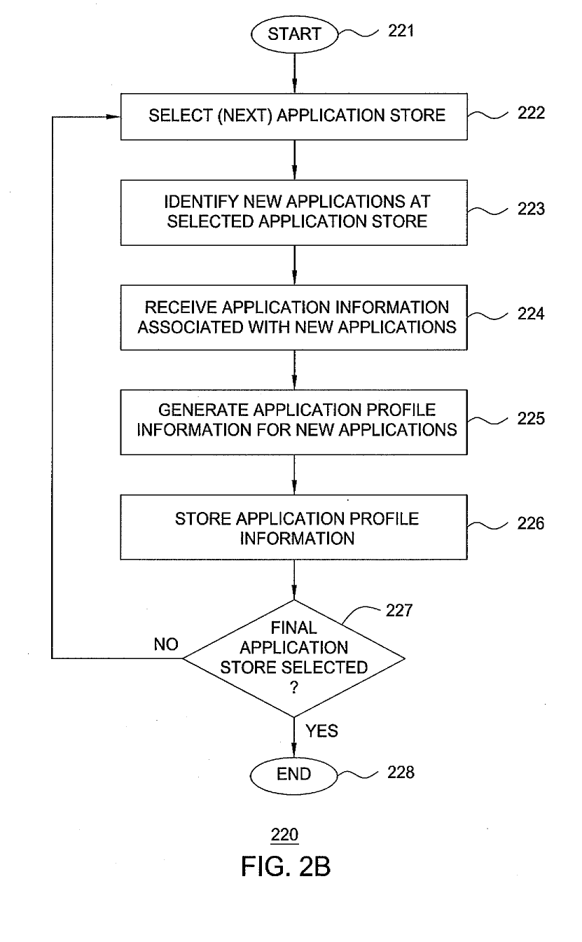

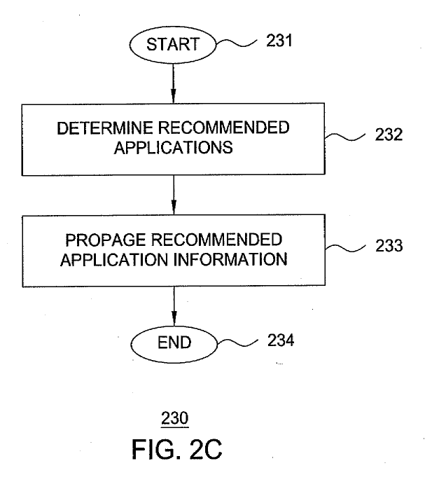

FIG. 2A depicts one embodiment of a method for generating user profile information for a user for use in recommending applications to the user. In one embodiment, method 210 of FIG. 2A is performed by an application guide server (e.g., AGS 120 depicted and described with respect to FIG. 1).

At step 211, method 210 begins.

At step 212, user information is received. The user information includes any information associated with the user which may be analyzed in order to determine the user profile information for the user (e.g., personal information of the user, preferences of the user, and the like, as well as various combinations thereof).

At step 213, the received user information is analyzed for generating the user profile information for the user. The analyzing of the received user information for generating the user profile information may be performed using any suitable profiling technologies.

At step 214, the user profile information is stored for use in recommending applications to the user. The use of user profile information for recommending applications to a user is depicted and described with respect to FIG. 2C.

At step 215, method 210 ends.

Although primarily depicted and described with respect to one user, it will be appreciated that method 210 of FIG. 2A is performed for each user in order to generate user profile information for each user.

Although omitted for purposes of clarity, method 210 of FIG. 2A may be initiated in response to any suitable trigger condition (e.g., periodically, based on the usage pattern of the associated user, and the like, as well as various combinations thereof).

FIG. 2B depicts one embodiment of a method for generating application profile information for applications for use in recommending applications to users. In one embodiment, method 220 of FIG. 2B is performed by an application guide server (e.g., AGS 120 depicted and described with respect to FIG. 1).

At step 221, method 220 begins.

At step 222, an (next) application store is selected.

At step 223, the application store is checked to identify new applications.

At step 224, for each new application that is identified, application information associated with the application is received. The application information may be received from any suitable source of such information (e.g., from the application store, directly from the application developer(s), from one or more other sources of application information, and the like, as well as various combinations thereof). The application information that is received may be pushed to the application guide server (e.g., in response to the check of the application store), pulled by the application guide server, and the like.

At step 225, the received application information is analyzed for generating the application profile information for the new application(s). The analyzing of the received application information for generating the application profile information may be performed using any suitable profiling technologies.

At step 226, the application profile information is stored for use in recommending applications to the user. The use of application profile information for recommending applications to users is depicted and described with respect to FIG. 2C.

At step 227, a determination is made as to whether the final application store has been selected. If the final application store has not been selected, method 220 returns to step 222, at which point a next application store is selected. If the final application store has been selected, the method 220 proceeds to step 228.

At step 228, method 220 ends.

Although primarily depicted and described with respect to an embodiment in which application profile information is generated for applications of all application stores, it will be appreciated that application profile information may be generated at any suitable granularity (e.g. for a subset of all application stores, for individual application stores, for groups of applications, on a per application basis, and the like, as well as various combinations thereof).

Although primarily depicted and described with respect to embodiments in which application profile information is generated only for new applications, it will be appreciated that application profile information also may be generated, modified, and/or deleted for existing applications.

Although omitted for purposes of clarity, method 220 of FIG. 2B may be initiated in response to any suitable trigger condition (e.g., periodically, in response to receiving indications of new applications being available and/or in response to receiving indications of existing applications being modified, and the like, as well as various combinations thereof).

FIG. 2C depicts one embodiment of a method for recommending applications to a user. In one embodiment, method 230 of FIG. 2C is performed by an application guide server (e.g., AGS 120 depicted and described with respect to FIG. 1).

At step 231, method 230 begins.

At step 232, the recommended applications for a user are determined.

In one embodiment, the recommended applications are selected for the user in advance of execution of method 230, in which case the recommended applications for the user may be determined by simply retrieving the list of recommended applications and associated recommended application information from memory.

In one embodiment, the recommended applications for a user are selected during execution of method 230 (i.e., selection of the recommended applications for the user is performed at the time at which the recommended applications are communicated to the user).

In such embodiments, selection of the recommended applications for the user is performed using user profile information of the user and application profile information of applications that are available for recommendation to the user for which the application recommendation process is being executed.

The selection of recommended applications for a user may be initiated in response to any suitable trigger condition(s) (e.g., periodically, in response to updating of the user profile information of the user, in response to updating of the application profile information of the applications, and the like, as well as various combinations thereof).

The selection of recommended applications for a user is performed using user profile information and application profile information. In one embodiment, selection of recommended applications for a user includes steps of (1) receiving user profile information of the user (e.g., from a database storing the user profile information), (2) receiving application profile information of the available applications (e.g., from a database storing the application profile information), and (3) selecting available applications for the user, as recommended applications to be recommended to the user, using the application profile information and the user profile information. The matching of application profile information and user profile information for purposes of selecting applications for users may be performed using any suitable profile matching technologies.

At step 233, recommended application information associated with the recommended applications is propagated from the application guide server to the mobile device of the user.

The recommended application information may be propagated from the application guide server to the mobile device of the user in any suitable manner (e.g., at any suitable time, in any suitable format, using any suitable communications technologies, and the like, as well as various combinations thereof).

In one embodiment, the recommended application information for a user is propagated to the mobile device of the user upon selection of recommended applications for the user.

In one embodiment, the recommended application information for a user is propagated to the mobile device of the user based on conditions at the mobile device of the user (e.g., in response to a determination that the mobile device is not currently being used or that activity on the mobile device is at least below a threshold, in response to a determination that the mobile device is being charged, in response to a determination that no communication cost (or at least limited cost) will be incurred, based on the location of the mobile device, and the like, as well as various combinations thereof).

The propagation of recommended application information to the mobile device of the user may be performed in any other suitable manner.

At step 234, method 230 ends.

Although omitted for purposes of clarity, method 230 of FIG. 2C may be executed in response to any suitable trigger condition. For example, method 230 may be executed periodically, in response to a request received from the user device of the user (e.g., where the mobile device may pull the recommended application information via a request initiated automatically by the user device, manually by a user of the user device, and the like), based on the usage pattern of the user, in response to n indication that user profile information of the user has changed, in response to an indication that one or more new applications are available and have been profiled, and the like, as well as various combinations thereof. It will be appreciated that, since selection of recommended applications for the user and propagation of the recommended application information to the user may be performed at different times (e.g., where profile matching is used for selecting the recommended applications for the user in advance of the time at which the recommended application information is propagated to the user), the trigger conditions which cause initiation of selection of recommended applications for the user and propagation of the recommended application information to the user may be different.

Although depicted as ending (for purposes of clarity), it will be appreciated that method 230 will continue to be repeated for enabling the application guide server to continue to recommend applications to the user. Although primarily depicted and described herein with respect to an embodiment in which method 230 is executed for a single user, it will be appreciated that method 230 may be adapted such that recommended applications may be selected for and communicated to a plurality of users (e.g., providing application recommendations for users having changes in their associated user profile information, providing application recommendations for some or all users in response to a determination that new applications are available and have been profiled, and the like, as well as various combinations thereof).

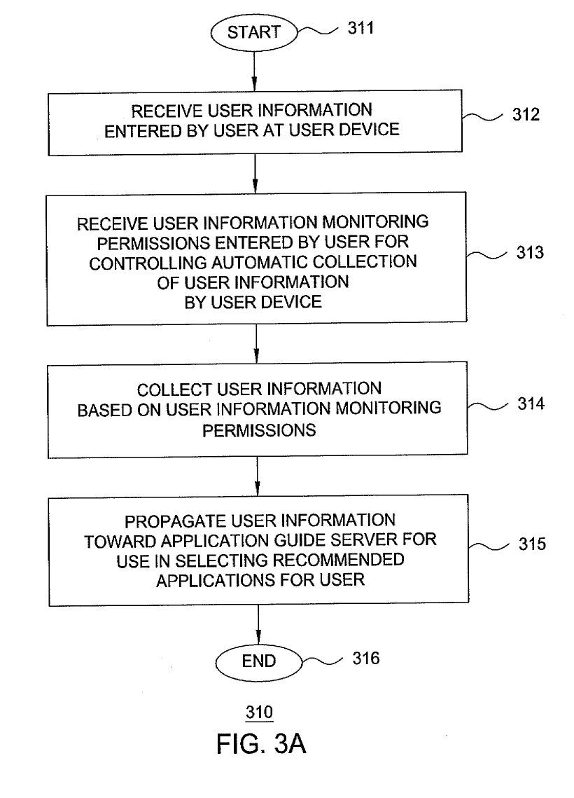

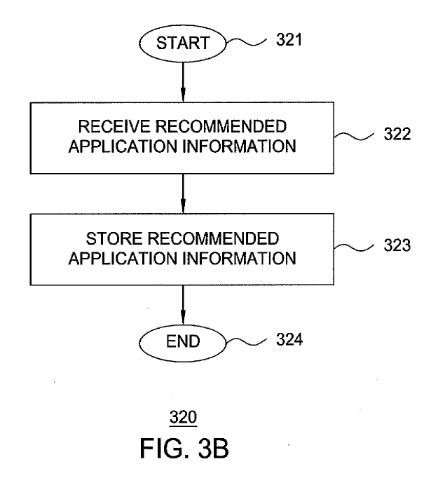

FIG. 3A depicts one embodiment of a method for providing user information of a user. In one embodiment, method 310 of FIG. 3A is performed by a mobile device of the user (e.g., MD 110 depicted and described with respect to FIG. 1).

At step 311, method 310 begins.

At step 312, user information entered manually by the user is received. The user information may include personal information of the user, preferences of the user, and the like, as well as various combinations thereof.

At step 313, user information monitoring permissions entered by the user are received. The user information monitoring permissions are configured for controlling automatic collection of user information by the user device. For example, user information monitoring permissions which may be set include one or more of the following parameters: whether or not the mobile device may read the contacts of the user, whether or not the mobile device may read the geographic location of the mobile device using GPS capabilities, whether or not the mobile device may scan the memory of the mobile device for files, whether or not the mobile device may access Internet browser logs, whether or not the mobile device may scan lists of applications available on the mobile device, and the like, as well as various combinations thereof.

At step 314, user information is collected automatically by the user device based on the user information monitoring permissions. For example, user information which may be collected includes one or more of contacts of the user, the geographic location of the mobile device, files stored on the mobile device, Internet browser logs of the mobile device, lists of applications available on the mobile device, and the like, as well as various combinations thereof.

At step 315, the user information is propagated from the mobile device toward at least one server (e.g., the application guide server and/or any other server suitable for receiving, analyzing, and profiling the user profile information). The user information that is propagated includes the manually entered user information and the automatically collected user information. The user information may be propagated in any suitable manner.

At step 316, method 310 ends.

Although depicted and described as ending (for purposes of clarity), it will be appreciated that the user may modify the manually entered user information and/or the user information monitoring permissions at any time, and that the user device will continue to collect user information based on the user information monitoring permissions.

Although omitted for purposes of clarity, it will be appreciated that user information manually entered by the user, user information monitoring permissions entered by the user, and user information automatically collected by the user device may be stored on the user device in any suitable manner.

Although primarily depicted and described with respect to embodiments in which the manually entered and automatically collected user information is propagated from the user device to the application guide server in a single step, it will be appreciated that the user information may be propagated from the user device to the application guide server in any suitable manner (e.g., propagating the manually entered user information at the time at which it is entered and propagating the automatically collected user information separately as periodic batches of information, propagating the manually entered user information at the time at which it is entered and propagating the automatically collected user information separately as the information is collected, and the like, as well as various combinations thereof).

FIG. 3B depicts one embodiment of a method for indicating availability of recommended application information to a user.

In one embodiment, method 320 of FIG. 3B is performed by a mobile device of the user (e.g., MD 110 depicted and described with respect to FIG. 1).

At step 321, method 320 begins.

At step 322, recommended application information is received. The recommended application information may be received from any suitable source of such information (e.g., from the application guide server).

At step 323, the recommended application information is stored. The recommended application information may be stored in any suitable format.

in one embodiment, the recommended application information may be stored such that it is associated with an AppGuide of the mobile device, thereby enabling presentation of the recommended application information via the AppGuide when the AppGuide is launched by the user.

In one embodiment, in which the recommended application information includes an application executable(s) for a recommended application(s), storage of the recommended application information includes automatic installation of the application executable(s) of the recommended application(s) on the mobile device.

At step 324, method 320 ends.

Although depicted and described as ending (for purposes of clarity), it will be appreciated that method 320 will continue to be repeated for enabling the user to receive new recommended application information for new applications recommended to the user by the application guide server.

Although depicted and described as ending (for purposes of clarity), it will be appreciated that, once the recommended application information is stored at the mobile device, the availability of the recommended application information at the mobile device may be indicated to the user.

The availability of the recommended application information may be indicated to the user in any suitable manner (e.g., using a visual indicator, using an aural indicator, via vibration of the mobile device, and the like, as well as various combinations thereof).

In one embodiment, availability of the recommended application information may be indicated to the user by modifying at least one characteristics of an icon of an AppGuide via which the recommended application information may be accessed (e.g., highlighting the icon, adding an indicator to the icon, and the like, as well as various combinations thereof). This will indicate to the user that new recommended application information is available.

In one embodiment, in which the recommended application information includes an application executable of an application, availability of the application executable of the application may be indicated to the user by causing an icon of the installed application to be displayed (e.g., on a main screen of the user device, via an AppGuide via which the recommended application information may be accessed, and the like, as well as various combinations thereof).

The availability of recommended application information may be indicated to the user in any other suitable manner.

In such embodiments, in which availability of recommended application information is indicated to the user when the recommended application information is received and stored at the mobile device, the user will be notified of new recommended application information on a regular basis and, thus, will be motivated to review the new recommended application information on a regular basis.

In one embodiment, in addition to indicating the availability of the recommended application information to the user when the recommended application information is received and stored at the mobile device, one or more additional indications of the availability of recommended application information may be provided to the user in response to other trigger conditions. For example, availability of recommended application information may be indicated to the user in response to a determination that a threshold length of time has passed without the user accessing new recommended application information for the first time, in response to a determination that the user previously accessed recommended application information but has not accessed the recommended application information again for a threshold length of time, in response to a determination that an application executable of a recommended application is set to be disabled or removed from the mobile device if a license is not purchased within a threshold length of time (e.g., based on a lifetime of the application executable), and the like, as well as various combinations thereof. The additional indications of availability of recommended application information may be provided at any suitable level of granularity. For example, additional indications of availability of recommended application information may be provided for all recommended application information as a whole (e.g., by modifying at least one characteristic of an icon of an AppGuide used for presenting the recommended application information), for individual applications of the recommended application information (e.g., by modifying at least one characteristic of individual icons of individual applications displayed on the main screen of the mobile device, by modifying at least one characteristic of information displayed within an AppGuide for individual applications of the recommended application information, and the like), and the like, as well as various combinations thereof.

Although depicted and described as ending (for purposes of clarity), it will be appreciated that, once the recommended application information is stored at the mobile device, the recommended application information may be presented to the user. It will be appreciated that, upon being notified of the availability of recommended application information, the user of the user device may or may not elect to review the recommended application information. It will be further appreciated that the user may elect to review recommended application information at any time, not just in response to an indication that new recommended application information has been received and stored at the mobile device. Accordingly, the recommended application information may be presented to the user via the mobile device at any suitable times and in response to any suitable trigger conditions. As described herein, recommended application information may be presented in any suitable manner. In one embodiment, recommended application information is presented via an AppGuide upon launching of the AppGuide (e.g., by the user and/or automatically by the mobile device in response to one or more trigger conditions). An exemplary AppGuide is depicted and described with respect to FIG. 5 and FIGS. 6A-6D.

Although primarily depicted and described with respect to embodiments in which the application guide server propagates recommended application information to the user device, in at least some embodiments the application guide server may propagate statistics of application downloads to the user device, thereby enabling the user to see which applications are most popular among other users.

In this manner, the application guide server is able to provide recommended application updates to a user and the user is provided with a dynamic, customized Application Guide presenting recommendation application information which changed dynamically, thereby motivating the user to regularly check the Application Guide for recommended applications that may be of interest to the user. The application guide server also is able to provide application download statistics to the user for enabling the user to see which applications are most popular among other users. This makes application marketing easier for application providers and makes application browsing and purchasing easier for users, as well as provides various other benefits which will apparent from the descriptions provided herein.

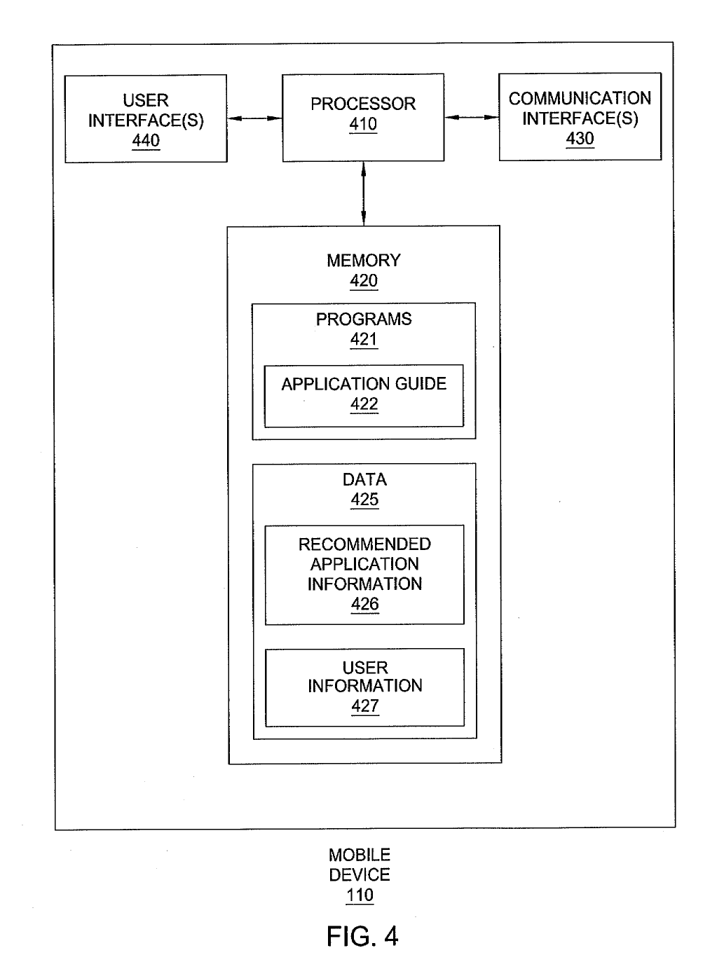

FIG. 4 depicts a high-level block diagram of one embodiment of a mobile device supporting an Application Guide.

As depicted in FIG. 4, mobile device 110 includes a processor 410, a memory 420, a communication interface(s) 430, and a user interface(s) 440.

The processor 410 controls the operation of MD 110. The processor 410 communicates with memory 420, communication interface(s) 430, and user interface(s) 440 for providing various functions of the application recommendation capability depicted and described herein (e.g., controlling functions such as execution of programs stored in memory 420, storage of data received via communication interface(s) 430, retrieval of data from memory 420 for transmission via communication interface(s) 430, propagation of data to user interface(s) 440, storage and/or transmission of data received via user interface(s) 440, and the like, as well as various combinations thereof).

The memory stores programs 421 and data 425 adapted for use in supporting the application recommendation capability.

The programs 421 include an Application Guide (AppGuide) 422. An exemplary AppGuide is depicted and described with respect to FIG. 5 and FIGS. 6A-6D. The programs 421 may include any other suitable programs.

The data 425 includes recommended application information 426 received from AGS 120 and user information 427 stored for propagation to AGS 120. The data 425 may include any other suitable data.

It will be appreciated that, although primarily depicted and described with respect to information adapted for use in supporting the application recommendation capability, memory 420 may store any other programs, data, and the like for supporting various other functions and capabilities of MD 110.

The communication interface(s) 430 includes any suitable communication interface(s), such as one or more of a cellular communication interface, a WiFi communication interface, and the like, as well as various combinations thereof.

The user interface(s) 440 includes any suitable user interface(s), such as one or more presentation interfaces (e.g., one or more speakers, one or more display screens, and the like) and one or more control interfaces (e.g., a keypad, a keyboard, one or more buttons, a touch screen, and the like, as well as various combinations thereof).

Although depicted and described with respect to specific types and arrangements of modules, it will be appreciated that MD 110 may be implemented using any other suitable types and arrangements of modules.

FIG. 5 depicts an exemplary representation of a mobile device, illustrating a main screen of the mobile device including an Application Guide icon.

As depicted in FIG. 5, the mobile device 500 includes a display screen 510 and a user interface 520.

The display screen 510 includes any display screen suitable for use in displaying information to the user. The display screen 510 supports a Graphical User Interface (GUI) facilitating display and navigation of the main screen of the mobile device, as well as any programs invoked on mobile device 500. The display screen 510 may or may not include touch screen capabilities. It will be appreciated that the display screen 510 is merely exemplary. The display screen of mobile device 500 may be implemented using any suitable type of display screen.

The user interface 520 includes any user interface means adapted for use by the user in interacting with mobile device 500. As depicted in FIG. 5, for example, the exemplary user interface 520 includes buttons enabling interaction with mobile device 500 (illustratively, buttons for placing a call, hanging up from a call, initiating a request, accessing one or more menus, as well as a “select” button for making selections). In one embodiment, user interface 520 may not be present or may include less buttons/controls (e.g., where the display screen 510 includes touch screen capabilities), so as to enlarge the size of display screen 510 and/or reduce the size of mobile device 500. It will be appreciated that user interface 520 is merely exemplary. The user interface of mobile device 500 may be implemented using any suitable user interface.

The design and operation of a mobile device, including the display screen(s) and the user interface(s) of the mobile device, as well as various other aspects and capabilities of mobile devices, will be understood by one skilled in the art.

As depicted in FIG. 5, display screen 510 displays a main screen 511, from which the user may navigate to access programs, content, data, and the like, as well as various combinations thereof.

The main screen 511 includes a number of icons 512 representing a number of programs available on the mobile device 500. For example, the icons 512 include a Contacts icon 512₁ representing a program storing user contacts and associated contact information, a Dialer icon 512₂ representing a program via which the user may dial a number to initiate a telephone call, a Messaging Icon 512₃ representing an Instant Messaging Program, a Browser icon 512₄ representing a program enabling the user to browse the Internet, and an AppGuide icon 512₅. It will be appreciated that the displayed icons 512 are merely exemplary, and that fewer or more, as well as different, icons 512 may be displayed on main screen 511 of mobile device 500. It will be appreciated that the arrangement of icons 512 on main screen 511 also is exemplary, and that icons may be arranged in any other suitable manner.

The main screen 511 also includes additional information and icons typically displayed on the main screen of a mobile device, such as the current date and time, an indication of the current wireless network with which the mobile device is associated, an indication of the current signal strength available to the mobile device for communication with the wireless network, and the like, as well as various combinations thereof.

The selection of icons 512 for launching the associated programs may be performed using the user interface 502 in any suitable manner, as will be understood by one skilled in the art.

In one embodiment, at least one characteristic of AppGuide icon 512₅ is changed in response to a trigger condition.

The AppGuide icon 512₅ may be changed in any manner suitable for indicating the change to the user. For example, the AppGuide icon 512₅ may be changed by replacing the existing icon with a different icon, modifying a portion of the icon, adding an indicator to the icon, highlighting the icon (which is illustrated in FIG. 5), and the like, as well as various combinations thereof.

The AppGuide icon 512₅ may be changed in response to any suitable trigger condition. For example, the trigger condition may be a determination that recommended application information has been received, a determination that new recommended application information has been received since the last time that the user accessed the AppGuide, a determination that the user has not accessed the AppGuide for a threshold length of time, and the like, as well as various combinations thereof.

As described herein, selection of the AppGuide icon 512₅ causes the AppGuide to be displayed on display screen 510.

In one embodiment, for one or more of the recommended applications for which recommended application information is received at MD 110, an associated recommended application icon may be displayed on the main screen 511 of MD 110.

The recommended application icon(s) may include an icon(s) for some or all of the recommended applications for which an associated application executable was provided in the recommended application information (e.g., an application executable that is installed on the mobile device for enabling a preview or trial of the associated application).

In one embodiment, where the recommended application information includes an application executable, an icon for the recommended application may be displayed on the main screen 511.

In one embodiment, where the recommended application information includes application executables for multiple recommended applications, icons for some or all of the recommended applications may be displayed on the main screen 511 (although all application executables will be accessible from the AppGuide).

In such embodiments, the display of a recommended application icon for a recommended application, on main screen 511, may be performed in place of or in addition to display of recommended application information for the recommended application using the AppGuide (e.g., that recommended application may or may not be listed in, and thus selectable from, the list of recommended applications that is displayed in the AppGuide).

The recommended application icon(s) displayed in main screen 511 may be modified in any suitable manner (e.g., in response to any suitable trigger conditions, with or without replacing recommended application icons removed from main screen 511, and the like, as well as various combinations thereof).

In one embodiment, the recommended application icon that is displayed for a recommended application may be removed from main screen 511 in response to one or more trigger conditions. For example, the recommended application icon that is displayed for a recommended application may be removed from main screen 511 in response to a determination that the user has not selected the recommended application icon after a threshold length of time after the recommended application icon was first made available via main screen 511 (e.g., after one day, two days, a week, or any other suitable length of time, which may or may not be configurable by the user). For example, the recommended application icon that is displayed for a recommended application may be removed from main screen 511 in response to selection of the recommended application icon and a determination that the user does not purchase the associated application. The recommended application icon that is displayed for a recommended application may be removed from main screen 511 in response to any other suitable trigger condition(s).

In one embodiment, some or all of the recommended application icon(s) displayed in main screen 511 are replaced with one or more different recommended application icon(s) in response to one or more trigger conditions. For example, replacement of a recommended application icon may be performed in response to removal of an existing recommended application icon from the main screen 511, each time recommended application information is received at the MD 110, periodically in time periods which may be shorter and/or longer that the time periods over which recommended application information is or is expected to be received, and the like, as well as various combinations thereof. In one embodiment, the recommended application icon that is removed may be replaced with another recommended application icon of another recommended application, which may be selected in any suitable manner (e.g., the recommended application last received at the MD 110, the next most popular application available as part of the recommended application information, and the like, as well as various combinations thereof). In one embodiment, the removal of the recommended application icon from the main screen 511 may be signaled to the application guide server such that the recommended application that was removed may be replaced with one or more new recommended applications (for which an associated recommended application icon(s) may be displayed in the main screen 511).

The selection, display, and/or modification of recommended application icons on main screen 511 may be provided in any other suitable manner.

As depicted in FIG. 5, an exemplary recommended application icon 513 for a recommended application is displayed on main screen 511.

An exemplary AppGuide is depicted and described with respect to FIGS. 6A-6D.

FIGS. 6A-6D depict an exemplary Application Guide (AppGuide) 600. As depicted in FIGS. 6A-6D, exemplary AppGuide 600 includes four tabs, including an exemplary recommended applications tab 610, an exemplary installed applications tab 620, an exemplary application search tab 630, and an exemplary user information tab 640.

FIG. 6A depicts an exemplary representation of the recommended applications tab 610 of an exemplary AppGuide.

The recommended applications tab 610 of exemplary AppGuide 600 displays at least a portion of the recommended application information. In one embodiment, recommended applications tab 610 displays a list of recommended applications 611. The list of recommended applications 611 may include any suitable recommended application information associated with recommended applications, such as one or more of the application names of the recommended applications, the application icons of the recommended applications, the like, as well as various combinations thereof. The list of recommended applications 611 may include less or more, as well as different, information associated with the recommended applications included in the list of recommended applications 611.

The recommended applications displayed in the recommended applications tab 610 may be arranged in any order. In one embodiment, for example, the recommended applications may be arranged in an order from highest probability match to lowest probability match based on the matching of the user profile information and the application profile information. In one embodiment, for example, the recommended applications may be arranged in an order from highest popularity to lowest popularity (e.g., amongst all users, amongst subsets of users (e.g., the user's friends), and the like). In one embodiment, for example, in which at least a portion of the recommended applications having application executables associated therewith (e.g., such that the user can preview the application or is provided an opportunity for a free trial use of the application), the applications having application executables associated therewith may be listed first, with the remaining recommended applications being listed in any suitable order thereafter. The recommended applications may be arranged in order based on any other suitable ordering criteria. The recommended applications may be arranged in order using various combinations of such ordering criteria. In one embodiment, the ordering criteria used to control the order in which the recommended applications are displayed may be configured by the user (e.g., via one or more of recommended applications tab 610, user information tab 640, and the like). In one embodiment, the order of the recommended applications may be modified by the user (e.g., by modifying the ordering criteria, using sort capabilities, and the like, as well as various combinations thereof).

The recommended applications displayed in the recommended applications tab 610 are selectable from the recommended applications tab 610. The recommended applications displayed in recommended applications tab 610 may be selected for initiating various actions. For example, selection of a recommended application may be performed for initiating display of additional information associated with the recommended application (e.g., a description of the application, a popularity rating of the application, a cost of purchasing the application, and the like, as well as various combinations thereof), initiating a request for a preview or trial of the recommended application (e.g., where such an application executable for the recommended application was not included within the recommended application information), initiating a request to activate a preview or trial of the recommended application (e.g., where an application executable for the recommended application was included within the recommended application information), initiating a request to rent or purchase the recommended application, initiating a request to recommend the recommended application to one or more friends of the user, and the like, as well as various combinations thereof. For at least a portion of these actions, initiation of the action may result in transmission of one or more messages from the mobile device (e.g., transmission of a request to purchase a license to use an application transmitted to the application guide server or to another server in response to initiation of a request to rent or purchase the recommended application, transmission of a message including a hyperlink to the application in response to initiation of a request to recommend the recommended application to one or more friends of the user, and the like, as well as various combinations thereof).

The recommended applications displayed in the recommended applications tab 610 may be managed in any suitable manner (e.g., added to and/or removed from recommended applications tab 610 at any suitable time and/or in response to any suitable trigger conditions(s)).

In one embodiment, a recommended application in the list of recommended applications is removed from the list of recommended applications upon expiration of a timer associated with the recommended application.

In one embodiment, a recommended application in the list of recommended applications is removed from the list of recommended applications in response to (1) selection of the recommended application by the user and (2) a determination that the user does not purchase the recommended application after selection of the recommended application. In one embodiment, this capability is supported for any of the recommended applications in the list of recommended applications. In one embodiment, this capability is supported only for those recommended applications having an application executable associated therewith (i.e., only for those recommended applications, in the list of recommended applications, that are previewed or trialed by the subscribed in response to selection of the recommended application by the user).

In one embodiment, a recommended application removed from the list of recommended applications is not replaced with another recommended application. In another embodiment, removal of the recommended application from the list of recommended applications may be signaled to the application guide server such that the recommended application that was removed may be replaced with one or more new recommended applications. Various other similar modifications to the list of recommended applications may be performed in response to any other suitable trigger conditions.

The management of the recommended applications displayed in the recommended applications tab 610 may be provided in any other suitable manner.

As depicted in FIG. 6A, for example, the list of recommended applications 611 includes a listing of five applications recommended to the user.

The list of recommended applications 611 includes, for each of the five applications, the application name of the recommended application and an associated icon of the recommended application (illustratively, represented by the box displayed to the left of the application name).

The list of recommended applications 611 also includes indicators that associated application executables have been downloaded for the first three applications in the list of recommended applications 611 (illustratively, represented by the circle displayed between the application icon and the name of the application). It will be appreciated that any suitable indicators may be used for indicating recommended applications for which application executables have been downloaded (e.g., using different colors, highlighting, and the like, as well as various combinations thereof).

As further depicted in FIG. 6A, for example, selection of the third application (RECOMMENDED APP 3) in the list of recommended applications 611 results in display of an action menu 612 including selectable menu items which, when selected, result in initiation of indicated actions for the third application. As depicted in FIG. 6A, action menu 612 includes a TRY APP 3 menu item for enabling the user to preview the third application, a BUY APP 3 menu item for enabling the user to purchase the third application, and a RECOMMEND menu item for enabling the user to recommend the third application to others. In this example, the third application has an associated application executable that has been downloaded and installed for enabling the user to preview the third application (thereby resulting in the availability of the TRY APP 3 menu item for the third application).

In the case in which the TRY APP 3 menu item is selected, the application executable which has already been downloaded to the mobile device is executed such that the third application is launched on the mobile device (i.e., the user does not have to wait for the application executable to be downloaded in order to preview the application).

In the case in which the BUY APP 3 menu item is selected, a capability is provided for enabling the user to purchase a license to use the third application. This may or may not involve additional interaction by the user via the AppGuide (e.g., entry of payment information). In one embodiment, for example, selection of the BUY APP 3 menu item automatically results in propagation, from the mobile device, of a request to purchase a license for the third application.

In the case in which the RECOMMEND menu item is selected, the recommendation may be provided in any suitable manner (e.g., via an SMS, MMS, email, or other type of message including a hyperlink via which the application may be previewed or purchased and installed; via an SMS, MMS, email, or other type of message including a name and/or other identifying information which may be used to search for the application, and the like, as well as various combinations thereof).

It will be appreciated that the information and associated capabilities depicted and described with respect to recommended applications tab 610 are merely exemplary and, thus, that recommended applications tab 610 may be used to display other information, display information in other arrangements and formats, provide access to other functions and capabilities, and the like, as well as various combinations thereof.

FIG. 6B depicts an exemplary representation of an installed applications tab of an exemplary AppGuide.

The installed applications tab 620 of the AppGuide 600 displays installed application information associated with applications downloaded and installed on MD 110. The installed applications may include applications downloaded and installed by the user (e.g., applications downloaded and installed in response to application searches performed by the user, applications downloaded and installed by the user based on recommendations presented to the user via the AppGuide, and the like), recommended applications automatically downloaded and installed on MD 110 (e.g., previews or trials of recommended applications), and the like, as well as various combinations thereof.

In one embodiment, installed applications tab 620 displays a list of installed applications 621. The list of installed applications 621 may include any suitable installed application information associated with installed applications, such as one or more of the application names of the installed applications, the application icons of the installed applications, the like, as well as various combinations thereof. The list of installed applications 621 may include less or more, as well as different, information associated with the installed applications included in the list of installed applications 621.

The installed applications displayed in the installed applications tab 620 may be arranged in any order. For example, the installed applications may be arranged in an order from most frequently used to least frequently used, in an order from most recently purchased to least recently purchased, in alphabetical order based on application name, and the like, as well as various combinations thereof. The installed applications may be arranged in order based on any other suitable ordering criteria. In one embodiment, the ordering criteria used to control the order in which installed applications are displayed may be configured by the user (e.g., via one or more of the installed applications tab 620, the user information tab 640, and the like). In one embodiment, the order of the installed applications may be modified by the user (e.g., by modifying the ordering criteria, using sort capabilities, and the like, as well as various combinations thereof).

The installed applications displayed in the installed applications tab 620 are selectable from the installed applications tab 620. The installed applications displayed in installed applications tab 620 may be selected for initiating various actions. For example, selection of an installed application may be performed for initiating display of information associated with the installed application (e.g., a description of the application, a popularity rating of the application, a cost of purchasing the application, and the like, as well as various combinations thereof), initiating a request to execute the application, initiating a process by which the user may enter a rating for the application, initiating a process for recommending the application, and the like, as well as various combinations thereof. For at least a portion of these actions, initiation of the action may result in transmission of one or more messages from the mobile device (e.g., transmission of a rating for the application to the application guide server or to another server configured for receiving and processing application rating information received from users, transmission of a message including a hyperlink to the application in response to initiation of a request to recommend the installed application to one or more friends of the user, and the like, as well as various combinations thereof).

The installed applications displayed in the installed applications tab 620 may be managed in any suitable manner (e.g., added to and/or removed from installed applications tab 620 at any suitable time and/or in response to any suitable trigger conditions(s)). In one embodiment, an application is moved from the list of recommended applications in the recommended applications tab 610 to the list of installed applications in the installed applications tab 620 in response to the user purchasing a license for the application. In one embodiment, an application is removed from the installed applications tab in response to the license for the application expiring without being renewed by the user. The management of the installed applications displayed in the installed applications tab 620 may be provided in any other suitable manner.

As depicted in FIG. 6B, for example, the list of installed applications 621 includes a listing of eight applications currently installed at the mobile device, and the list of installed applications 621 includes, for each of the eight applications, the application name of the recommended application and an associated icon of the installed application (illustratively, represented by the box displayed to the left of the application name). As further depicted in FIG. 6B, for example, selection of the sixth application (APP 6) in the list of installed applications 621 results in display of an action menu 622 including selectable menu items which, when selected, result in initiation of indicated actions for the sixth application (illustratively, a VIEW DETAILS menu item for enabling the user to view details associated with the sixth application, a START menu item for enabling the user to launch the sixth application, a RATE menu item for enabling the user to enter a rating for the sixth application, and a RECOMMEND menu item for enabling the user to recommend the sixth application to others). In the case in which the RECOMMEND menu item is selected, the recommendation may be provided in any suitable manner (e.g., via an SMS, MMS, email, or other type of message including a hyperlink via which the application may be previewed or purchased and installed; via an SMS, MMS, email, or other type of message including a name and/or other identifying information which may be used to search for the application, and the like, as well as various combinations thereof). In the case in which the RECOMMEND menu item is selected, the recommendation may be provided in any suitable manner (e.g., via an SMS, MMS, email, or other type of message including a hyperlink via which the application may be previewed or purchased and installed; via an SMS, MMS, email, or other type of, message including a name and/or other identifying information which may be used to search for the application, and the like, as well as various combinations thereof). It will be appreciated that the information and associated capabilities depicted and described with respect to installed applications tab 620 are merely exemplary and, thus, that installed applications tab 620 may be used to display other information, display information in other arrangements and formats, provide access to other functions and capabilities, and the like, as well as various combinations thereof.

FIG. 6C depicts an exemplary representation of an application search tab of an exemplary AppGuide.

The application search tab 630 of the AppGuide 600 provides a capability for enabling the user to search for applications. The search may be a search for one or more of installed applications (e.g., installed applications that are owned by the user or available to be previewed or trialed by the user), applications available from the Application Guide Server, and the like, as well as various combinations thereof. In other words, the search may be performed locally on the mobile device of the user and/or remotely on the Application Guide Server. The application search tab 630 may be configured to enable any suitable granularity of search using any suitable search criteria. The application search tab 630 may be configured to enable sorting of search results, refinement of search results through use of additional search criteria, and the like, as well as various combinations thereof. The manner in which such search capabilities may be provided will be understood by one skilled in the art.

As depicted in FIG. 6C, for example, application search tab 630 may include a plurality of search options 631 enabling specification of different types of search criteria.

A first search option 631_{A}, for example, is a search in which the user may manually request execution of the application recommendation process by the application guide server. In this case, selection of the RECOMMEND APPLICATIONS button causes initiation of a request to the application guide server which, when received, causes the application guide server to provide recommended applications to the mobile device (e.g., via execution of method 230 of FIG. 2C).

A second search option 631_{B}, for example, is a simple keyword search in which the user enters one or more keywords and selects a SUBMIT button in order to submit the one or more keywords, which are then compared against application information (e.g., application names, application types, application descriptions, application metadata, and the like, as well as various combinations thereof) in order to identify and display applications that match the entered keyword(s).

A third search option 631_{C}, for example, is an advanced search in which the user may specify search criteria (e.g., application type, application popularity, application release date, application price, and the like, as well as various combinations thereof) in order to identify and display applications that match the search criteria. The search criteria may be entered by the user (e.g., an application name, an application type, and the like) and/or selected by the user (e.g., an application popularity that is specified via selection of one of a plurality of priority levels available from a drop-down menu, an application price that is specified via selection of one of a plurality of application price ranges available from a drop-down menu, and the like).

It will be appreciated that any other suitable search options may be utilized. It will be appreciated that various combinations of such search options may be utilized.

Although omitted for purposes of clarity, in one embodiment the application search tab 630 may display (or at least provide a capability for the user to access) application usage information indicative of usage/popularity of available applications. For example, the application usage information may include real-time statistics associated with available applications that other users are previewing or purchasing (e.g., a list of the top ten most previewed applications, a list of the top ten most purchased applications, and the like, as well as various combinations thereof). The application usage information may include any other similar information which might be useful to the user of MD 110 in identifying applications that are or may be popular with other users over any suitable time scales (e.g., the most popular applications of the day, week, year, and the like).

FIG. 6D depicts an exemplary representation of a user information tab of an exemplary AppGuide.

The user information tab 640 of the AppGuide 600 provides a capability for enabling the user to provide user information and/or to control collection of user information by MD 110.

As depicted in FIG. 6D, for example, user information tab 640 may include an PERSONAL INFORMATION button 641 which, when selected, provides a capability for the user to manually update personal information, such as the age of the user, the gender of the user, one or more addresses of the user, and the like, as well as various combinations thereof.

As depicted in FIG. 6D, for example, user information tab 640 may include a USER PREFERENCES button 642 which, when selected, provides any suitable means by which the user may specify preferences. For example, selection of USER PREFERENCES button 642 may launch a user preference survey or provide a menu from which one or more user preference surveys may be launched. The user preference survey(s) may include any suitable questions for use in providing additional user profile information for use by AGS 120 in selecting recommended applications for the user. For example, the user preference survey(s) may collect information related to the type of work done by the user, likes and/or dislikes of the user (e.g., television shows, movies, websites, hobbies, and the like), financial information about the user, and the like, as well as various combinations thereof. The user preference survey(s) may include any suitable number(s) and format(s) of questions (e.g., true-false, multiple choice, answer entry, and the like, as well as various combinations thereof). The user preference survey(s) may build upon the more basic personal information that is typically maintained as part of the personal information described with respect to PERSONAL INFORMATION button 641.

As depicted in FIG. 6D, for example, user information tab 640 may include a user information monitoring permissions button 643 which, when selected, provides a capability for the user to set one or more user information monitoring permissions utilized by the MD 110 for automatically collecting user information at the MD 110. In one embodiment, for example, the types of user information monitoring permissions which may be set include one or more of the following parameters: whether or not MD 110 may read the contacts of the user, whether or not MD 110 may read the geographic location of MD 110 using GPS capabilities, whether or not the MD 110 may scan the memory of the MD 110 for files, whether or not the MD 110 may access Internet browser logs, whether or not the MD 110 may scan lists of applications available on MD 110, and the like, as well as various combinations thereof. The user n preferences monitoring permissions may be specified in any suitable manner (e.g., by using respective enable/disable check boxes for each of the parameters of the user information monitoring permissions, or in any other suitable manner).

It will be appreciated that the user information may include any user information which may be useful in recommending applications to the user.

It will be appreciated that any of the user information (e.g., user information provided by the user via the user information tab 640, user information collected by the MD 110 based on user preference information monitoring permissions specified via the user information tab 640, and the like, as well as various combinations thereof) may be propagated from MD 110 to AGS 120 in any suitable manner (e.g., at any suitable time(s), in response to any suitable trigger condition(s), in any suitable communications format, and the like, as well as various combinations thereof). It will be further appreciated that such user information provided from MD 110 may be stored within user profile database 121_{U}, processed for storage within user profile database 121_{U}, and the like, as well as various combinations thereof, such that the user information is available as at least a part of the user profile information for use by AGS 120 in selected recommended applications for the user of MD 110.

As described herein with respect to exemplary AppGuide 600 of FIGS. 6A-6D, navigation of the exemplary AppGuide 600, or any other similar AppGuide, may be performed in any suitable manner. In one embodiment, for example, upon launching of the AppGuide by the user, the user may be provided with options for viewing recommended application information, previewing recommended applications, searching for applications, rating installed applications, specifying user information associated with the user, viewing real-time statistics on applications downloaded by other users, and the like, as well as various combinations thereof. For example, upon viewing recommended application information, the user may be presented with options such as purchasing licenses for applications, recommending applications to friends, and the like. For example, upon previewing applications, the user may be present with options to purchase licenses to use the applications, options to delete the applications from the list of recommended applications, and the like. For example, in searching for applications, the user may specify parameters which are then provided to the application guide server as a search query string, and the user may then be presented with personalized search results. For example, in rating installed applications, the user enters ratings for the installed applications and the ratings are communicated from the user device to a server (e.g., to the application guide server or any other suitable server) for use in providing application rating information to other users. For example, in specifying user information, the, user may enter user information which is then provided from the user device to the application guide server to be profiled for use in selecting recommended applications for the user. These and various other functions and capabilities supported by the exemplary AppGuide will be understood by one skilled in the art and informed by the teachings herein.

With respect to the exemplary AppGuide 600 of FIGS. 6A-6D, it will be appreciated that the design and operation of the exemplary AppGuide 600 may be modified in any suitable manner as will be understood by one skilled in the art. For example, although primarily depicted and described with respect to an exemplary AppGuide 600 having four tabs, it will be appreciated that the AppGuide 600 may include fewer or more, as well as different, tabs. For example, although primarily depicted and described with respect to an exemplary AppGuide 600 having a particular arrangement of displayed information and available functions and capabilities, it will be appreciated that the displayed information and/or functions and capabilities depicted and described herein may be arranged within an AppGuide 600 in any other suitable manner. For example, although primarily depicted and described with respect to use of tabs, buttons, drop-down menus, data entry fields, and like user interface means, it will be appreciated that any suitable user interface means may be used for navigating AppGuide 600, making selections within AppGuide 600, entering information into AppGuide 600, and performing like functions, as well as various combinations thereof. In other words, the exemplary AppGuide 600 depicted and described herein is merely exemplary and any other suitable AppGuide may be used for providing the various functions of the application recommendation capability.

Although primarily depicted and described with respect to automatic installation of application executables of recommended applications, it will be appreciated that such references to installation of application executables of recommended applications may be read more generally as being installation of recommended applications, which may include any actions that may be performed in order to install an application on a device (e.g., installation, execution, and/or any other processing of any programs, files, and/or any other information that may be performed in order to install an application on a device).

Although primarily depicted and described herein with respect to embodiments for recommending applications to users in mobile networks, in other embodiments the principles of the application recommendation capability may be utilized for recommending applications to users in other types of networks.

Although primarily depicted and described herein with respect to recommending applications to users, in other embodiments the principles of the application recommendation capability may be utilized for recommending other types of content to users (e.g., music, television programs, movies, software programs, video games, and the like).

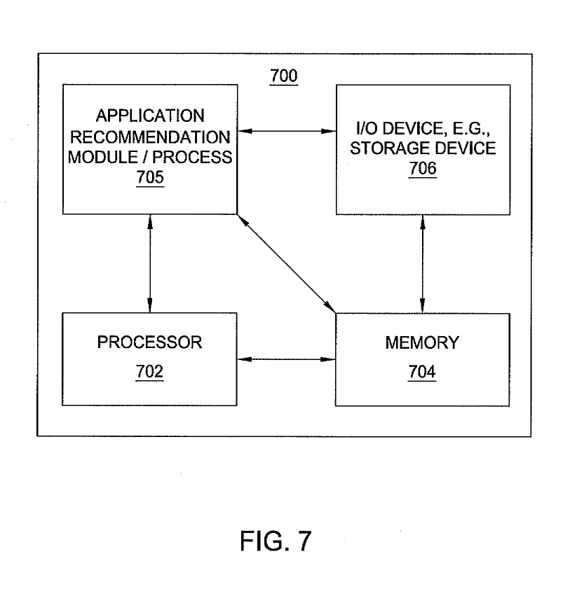

FIG. 7 depicts a high-level block diagram of a computer suitable for use in performing the functions described herein. As depicted in FIG. 7, computer 700 includes a processor element 702 (e.g., a central processing unit (CPU), two or more co-processors, and/or other suitable processor(s)), a memory 704 (e.g., random access memory (RAM), read only memory (ROM), and the like), an application recommendation module/process 705, and various input/output devices 706 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It is contemplated that the functions depicted and described herein may be implemented in software, hardware, and/or a combination of software and hardware, e.g., using a general purpose computer, one or more application specific integrated circuits (ASIC), and/or any other equivalents. In one embodiment, application recommendation process 705 can be loaded into memory 704 and executed by processor 702 to implement the functions as discussed hereinabove. As such, application recommendation process 705 (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method, comprising:
selecting an application to recommend to a user based on user profile information associated with the user and application profile information associated with the application; and
propagating recommended application information toward a user device of the user, wherein the recommended application information comprises an application executable of the recommended application.

2. The method of claim 1, wherein the recommended application information comprises a list of a plurality of applications recommended for the user of the user device.

3. The method of claim 2, wherein, for each of the recommended applications, the recommended application information comprises a description of the recommended application.

4. The method of claim 1, wherein the application executable is configured for providing at least one of a preview of the recommended application and a trial of the recommended application.

5. The method of claim 1, wherein the application executable has a lifetime associated therewith.

6. The method of claim 5, wherein the application executable is configured for being automatically disabled or removed from the user device at the end of the lifetime unless a license for the recommended application is purchased by the user.

7. The method of claim 1, further comprising:
receiving, from the user device, a request to purchase a license for the recommended application.

8. The method of claim 1, wherein the recommended application information is pushed toward the user device.

9. The method of claim 1, wherein the user profile information comprises at least one of information entered by the user via the user device and information automatically collected by the user device based on information collection permissions set on the user device.

10. An apparatus, comprising:
a processor configured for:
selecting an application to recommend to a user based on user profile information associated with the user and application profile information associated with the application; and
propagating recommended application information toward a user device of the user, wherein the recommended application information comprises an application executable of the recommended application.

11. An apparatus, comprising:
a processor configured for:
receiving, at a user device, recommended application information comprising an application executable of an application recommended for a user of the user device; and
automatically installing the application executable of the recommended application on the user device.

12. The apparatus of claim 11, wherein the application executable is configured for providing at least one of a preview of the recommended application and a trial of the recommended application.

13. The apparatus of claim 11, wherein the application executable has a lifetime associated therewith.

14. The apparatus of claim 13, wherein the processor is configured for automatically disabling the recommended application or removing the recommended application from the user device at the end of the lifetime unless a license for the recommended application is purchased by the user.

15. The apparatus of claim 11, wherein the processor is configured for initiating propagation, from the user device, of a request to purchase a license for the recommended application.

16. The apparatus of claim 11, wherein the processor is configured for initiating presentation of an indication of availability of the recommended application at the user device.

17. The apparatus of claim 16, wherein the indication of availability of the recommended application at the user device is adapted for being presented by automatically displaying an icon of the recommended application via a display of the user device.

18. The apparatus of claim 16, wherein the recommended application information is adapted for being presented via an application guide on the user device, wherein the application guide has an application guide icon associated therewith, wherein the indication of availability of the recommended application at the user device is adapted for being presented by automatically modifying at least one characteristic of the application guide icon.

19. The apparatus of claim 16, wherein the recommended application information is adapted for being presented via an application guide available on the user device, wherein the indication of availability of the recommended application at the user device is adapted for being presented via the application guide.

20. The apparatus of claim 11, further comprising:
a memory configured for storing the recommended application information.

21. The apparatus of claim 11, further comprising:
a display configured for displaying the recommended application information.

22. The apparatus of claim 11, wherein the processor is configured for running an application guide.

23. The apparatus of claim 22, wherein the application guide is configured for presenting the recommended application information.

24. The apparatus of claim 22, wherein the application guide is configured for presenting at least one of:
installed application information associated with at least one application installed on the user device;
an application search capability configured for use in searching for one or more available applications; and
a user information capability configured for use in entry of at least one of:
user information associated with the user; and
user information monitoring permissions configured for controlling automatic collection of user information by the user device.

25. The apparatus of claim 11, wherein the processor is configured for:
receiving user information associated with the user of the user device, wherein the user information is entered via at least one user interface of the user device; and
initiating propagation of the user information from the user device toward a server.

26. The apparatus of claim 11, wherein the processor is configured for:
automatically collecting user information at the user device based on control information adapted for controlling automatic collection of user information by the user device; and
initiating propagation of the collected user information from the user device toward a server.

27. The apparatus of claim 11, wherein the recommended application information comprises a list of a plurality of applications recommended for the user of the user device.

28. A method, comprising:
receiving, at a user device, recommended application information comprising an application executable of an application recommended for a user of the user device; and
automatically installing the application executable of the recommended application on the user device.
